(19) United States
(12) Patent Application Publication
(10) Pub. No.: US 2008/0010020 A1
(43) Pub. Date: Jan. 10, 2008

(54) Method and System of Diagnosing Production Changes

(75) Inventors: Damon J. Ellender, Loftus (AU); Duane B. Toavs, Taylor, TX (US)

Correspondence Address: CONLEY ROSE, P.C.;David A. Rose, P. O. BOX 3267, HOUSTON, TX, 77253-3267, US

(73) Assignee: DANIEL MEASUREMENT AND CONTROL, INC., Houston, TX (US)

(21) Appl. No.: 11/774,721

(22) Filed: Jul. 9, 2007

Related U.S. Application Data
(60) Provisional application No. 60/806,867, filed on Jul. 10, 2006.

(51) Int. Cl. G01V 1/40; G05B 13/02; G05B 15/00

(52) U.S. Cl. 702/6; 706/23

(57) ABSTRACT

Method and system of diagnosing production changes. At least some of the illustrative embodiments are systems comprising a plurality of devices configured to measure production parameters associated with a hydrocarbon producing well, and a processor proximate to a wellhead of the hydrocarbon producing well and electrically coupled to the plurality of devices. The processor is configured to diagnose a cause of a change of a production parameter.

### CROSS-REFERENCE TO RELATED APPLICATIONS

This application claims the benefit of provisional application Ser. No. 60/806,867, filed Jul. 10, 2006, and entitled “Intelligent Wellhead Management”, which application is incorporated by reference herein as if reproduced in full below.

### BACKGROUND

In most cases, production of hydrocarbons from an underground reservoir takes place by way of plurality of wells drilled into the underground reservoir. Collectively, wells drilled into a particular underground reservoir are called a field or production field. Most production fields do not have flow meters installed at each well because of the expense of flow meters and/or because the multi-phase flow directly from the well does not lend itself well to direct flow measurement. Rather, the production for the field is accumulated, and a portion of the total accumulation is attributed to each well based on a periodic testing of the flow rate of each well. Stated otherwise, the flow from each well is periodically (e.g., monthly) separated into its various constituents (e.g., oil, gas, water) and tested measured, and the hydrocarbons produced by each well is determined by attributing a portion of the production by the entire field to each well based on flow rate measured in the periodic test. However, the amount of hydrocarbon flow may change, yet that change may not be noted for attribution purposes until the next periodic testing.

Because most production fields do not have flow meters at each well, determining whether there has been a change in flow, and/or the cause of the change, is difficult without specific testing or inspection. For example, in a situation of a well producing hydrocarbons by way of a pump jack, the well may experience mechanical problems (e.g., sucker rod assembly breakage, sucker rod assembly stretch, pump jack arm stretch, and down hole pump seal leakage) that affect hydrocarbon flow, yet it is difficult to determine that a mechanic problem has occurred without traveling to the well site and/or performing specific testing.

### BRIEF DESCRIPTION OF THE DRAWINGS

For a detailed description of the various embodiments, reference will now be made to the accompanying drawings in which:

FIG. 1 shows a hydrocarbon producing well and related systems in accordance with at least some embodiments;

FIG. 2 shows a multi-dimensional space for use with an illustrative k-nearest neighbor artificial intelligence classifier;

FIG. 3 shows a hydrocarbon producing well and related systems in accordance with alternative embodiments; and

FIG. 4 shows a method in accordance with various embodiments.

### NOTATION AND NOMENCLATURE

Certain terms are used throughout the following description and claims to refer to particular system components. This document does not intend to distinguish between components that differ in name but not function.

In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct connection. Thus, if a first device couples to a second device, that connection may be through a direct connection, or through an indirect connection via other devices and connections.

### DETAILED DESCRIPTION

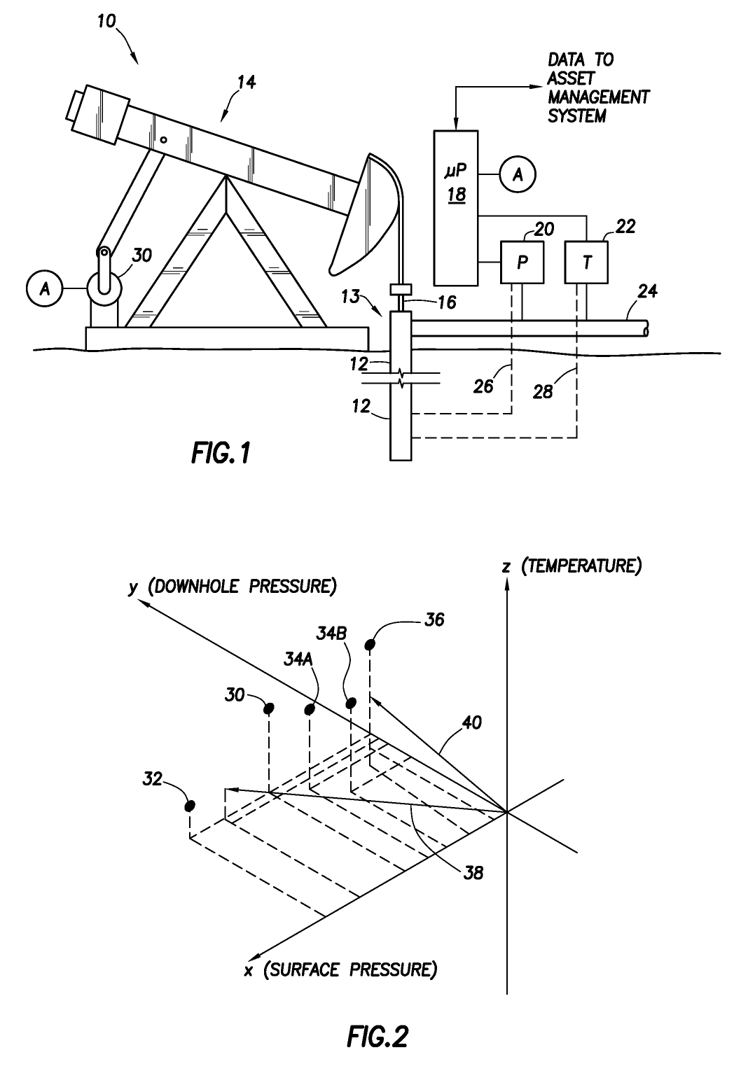

FIG. 1 illustrates a hydrocarbon production system 10 in accordance with at least some embodiments. In particular, FIG. 1 illustrates a hydrocarbon well 12 having a wellhead 13. The illustrative well 12 of FIG. 1 uses a pump jack 14, sucker rod assembly 15 and a down hole pump to extract hydrocarbons (such as oil). Proximate to the wellhead 13 is a processor 18 coupled to various devices that monitor or read production parameters (e.g., illustrative pressure transmitter 20 and temperature transmitter 22).

In accordance with at least some embodiments, the pressure transmitter 20 detects pressure of the hydrocarbons proximate to the wellhead 13, such as in production piping 24. Likewise, in some embodiments the temperature transmitter 22 detects temperature of the hydrocarbons proximate to the wellhead 13, such as in production piping 24. In alternative embodiments, the pressure transmitter 20 and temperature transmitter 22 are located at the surface, but sense pressure and temperature respectively at a down hole location (e.g., near a down hole pump or near the casing perforations). The alternative embodiments where down hole pressure and temperature are sensed are illustrated by dashed lines 26 and 28. FIG. 1 illustrates the pressure transmitter 20 and temperature transmitter 22 at the surface, but in other embodiments these devices may be physically located down hole, with their measurement parameters sent up hole by way of electrical conductors. In yet still further embodiments, both surface and down hole pressures and temperatures are sensed.

In accordance with various embodiments, the processor 18 monitors the production parameters, such as pressure and temperature, and periodically reports production parameters to a remotely located asset management system. Further, the processor 18 may, acting on its own or based on commands from remote locations, control production of the well 12. In the case of the illustrative well 12 using a pump jack 14, the processor 18 may control production by selectively operating the electric motor 30 of the pump jack 14. Monitoring various production parameters (e.g., pressure, temperature, drive motor 18 electrical current or torque), on-off control and reporting monitored parameters may be referred to as remote terminal unit (RTU) functions.

In addition to the RTU functions, and in accordance with various embodiments, the processor 18 is configured to determine or diagnose causes of changes of production parameters which heretofore have dictated physical inspection and/or testing at the wellhead. A problem with diagnosing causes of changes in production parameters is that normally occurring fluctuations in monitored parameters mask underlying causes. Monitoring a single, or even multiple, variables and attempting to establish the existence of a change in production parameter in a Boolean sense may not be possible.

As an example of the potential shortcomings in trying to diagnose a cause of a change in production parameters, consider the system of FIG. 1 attempting to determine the cause of reduced pressure in the production piping 24. All other parameters held constant, pressure measurements of produced hydrocarbons in the production piping may be indicative of the flow rate. Thus, reduced pressure in the production piping 24 may be caused by a reduced flow rate. However, as temperature changes, the viscosity of the oil of the produced hydrocarbons changes, which affects flow rate. Thus, the illustrative reduced pressure in production piping 24 may not indicate a change in production flow rate if accompanied by an increase in temperature of the hydrocarbons. Further still, a change of pressure down hole (formation pressure) affects surface pressure and flow rate (higher down hole pressure, more surface flow), and thus a reduced pressure in the production piping 24 and unchanged measured temperature, if accompanied by a reduced down hoe pressure, may indicate a flow rate change.

Moreover, the cause of the illustrative reduced pressure in the production piping 24 may be based on mechanical difficulties. If the reduced pressure in the production piping 24 is unaccompanied by a change in the down hole (formation) pressure, the reduced pressure may indicate an underlying mechanical problem (e.g., problems with the pump jack 14, sucker rod 16, down hole pump). Relatedly, if the reduced pressure in the production piping is also accompanied by a substantially low down hole (formation) pressure (i.e., outside the expected fluctuation range of the formation pressure), the status of the completion of the well may have changed (e.g., subsurface collapse closing off hydrocarbon flow pathways in rock fractures, perforation in casing clogged with sand or other particles). Compounding the difficulty in making determinations as to the cause of changes is that production parameters are not Boolean values. Thus, in the illustrative system of FIG. 1, the magnitude of a surface measured pressure needs to be considered with the magnitude of surface temperature along with the magnitude of down hole pressure (and possibly other parameters) in determining the cause of the change in production parameters.

In order to make determinations as to the cause of changes in production parameters, in some embodiments the processor 18 is programmed to implement artificial intelligence. Viewing and analyzing various production parameters (e.g., pressures, temperatures, power consumptions, and electrical current flow) the artificial intelligence implemented in the processor 18 makes determinations as to the cause of changes in production parameters, and reports those causes to the asset management system. Based on the reporting, crews may be sent to the particular wellhead if the cause is one which may be addressed. An illustrative but non-limiting list of causes of production parameters changes that the processor 18 may report for the system of FIG. 1 is: flow changes caused by formation pressure changes; flow changes indicative of mechanical problems; abnormally high sand production; sucker rod stretch; pump jack arm stretch; sucker rod assembly breakage; completion changes (e.g., formation changes, perforation clogging); high/low gas lift pressure in gas lift systems; and down hole pump seal leakage.

The artificial intelligence implemented in accordance with the various embodiments may be termed an artificial intelligence classifier. There are several artificial intelligence classifiers that may be operable in the various embodiments (e.g., neural networks, support vector machine, k-nearest neighbor algorithms, Gaussian mixture model, Bayes classifiers, and decision tree). Although the illustrative classifiers may have different theoretical and mathematical basis, classifiers in accordance with at least some embodiments analyze measured production parameters against a set of predetermined production parameter states that indicate different causes. Given the analog nature of most measured production parameters, rarely will the measured parameters fall squarely within a set of parameters indicating a particular cause. Thus, the artificial intelligence system decides which among the potential causes is the most likely candidate.

Consider, as an example, an illustrative embodiment of the processor 18 implementing artificial intelligence in the form of the k-nearest neighbor algorithm, and using the algorithm to diagnose a cause of a change in production parameters. The k-nearest neighbor algorithm may be conceptualized as each measured parameter defining a dimension in a multi-dimensional space. Various predetermined causes of production parameter changes may be defined as points within the multi-dimensional space (or as vectors from the origin to those points). FIG. 2 illustrates a three-dimensional space, with the X-axis related to pressure measured in the production piping 24, the Y-axis related to pressure measured proximate to casing perforations, and the Z-axis related to temperature measured in the production piping 24. A three-dimensional space is selected for explanation as three dimensions can be visualized better than four or more dimensions. However, the artificial intelligence program may implement any number of dimensions when implementing the k-nearest neighbor algorithm. Point 30 may be illustrative of operating conditions when the well and related equipment are working properly—relatively high down hole (formation) measured pressure, surface (production) pressure at a predetermined value, and surface measured temperature at a predetermined value. Point 32 may be illustrative of a situation where viscosity of the oil in the produced hydrocarbons changes but flow remains constant (i.e., reduced temperature and higher surface pressure). Points 34A and 34B may be illustrative of a family of situations where down hole (formation) pressure drops, resulting in lower surface pressure, but otherwise no mechanical failure. Point 36 may be illustrative of failure of down hole (e.g., pump failure, pump seal leakage), with formation pressure relatively unchanged but surface pressure low. These causes of changes in production parameters are merely illustrative, and other causes have entries in the multi-dimensional space as well.

In operation, the processor 18 reads production parameters from devices such as transmitters (e.g., down hole pressure, surface pressure, temperature). Using the values of the production parameters a vector 38 is created, and the vector 38 is compared against the various predefined points/vectors that relate to specific causes of changes in production parameters. In the illustrative situation of FIG. 2, the nearest neighbors of vector 38 are a vector to point 32 (low temperature, but unchanged flow) and a vector to point 30 (expected operating pressures and temperature). If the “k” in the k-nearest neighbor algorithm is selected to be one, then the determination is based on the single nearest neighbor, and thus production parameters resulting in vector 38 may be diagnosed as a change in viscosity of the produced oil (i.e., the cause of point 32). Now consider reading production parameters to obtain values that define vector 40. In the illustration of FIG. 2, the nearest neighbors are the vectors to points 34A and 34B relating to formation pressure change, and point 36 relating to pump failure. If the “k” in the k-nearest neighbor algorithm is selected to be two, then the determination is based on the two nearest neighbors in the same category. Thus, a change in production parameters resulting in vector 40 may be diagnosed as a change in formation pressure (i.e., the cause of points 34A and 34B). Note that the diagnosis of the cause might be different with respect to vector 40 if k is selected as one rather two. The k-nearest neighbor artificial intelligence classifier discussed with respect to FIG. 2 is merely illustrative of the various types of classifiers that may be used to diagnose the cause of production parameter changes.

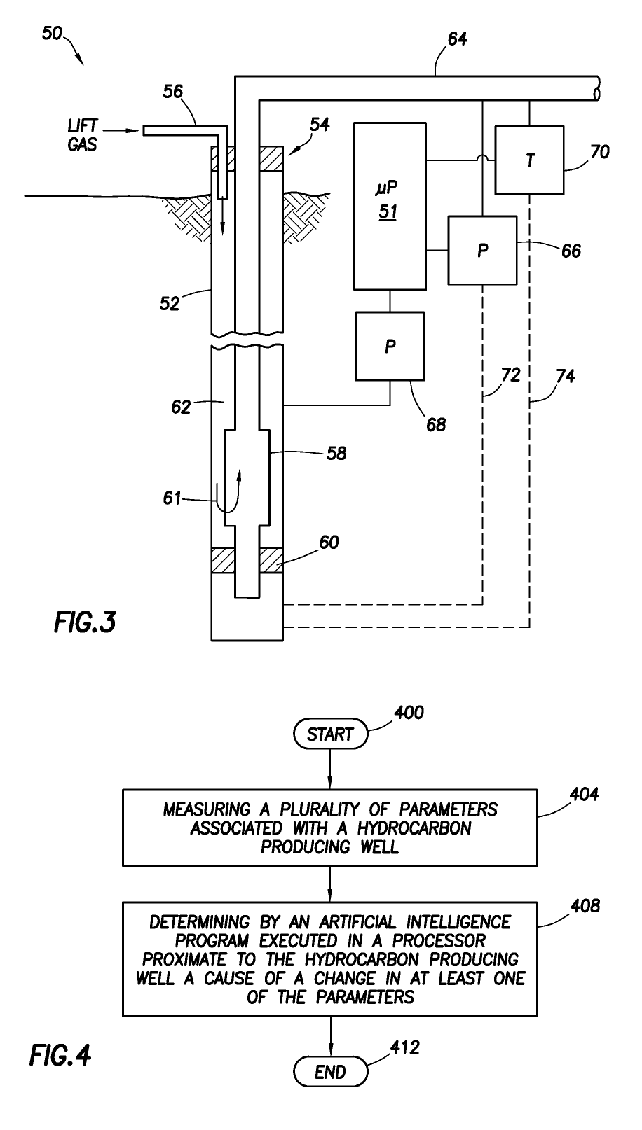

FIG. 3 illustrates a hydrocarbon production system in accordance with alternative embodiments. In particular, FIG. 3 illustrates an oil well 52 having a wellhead 54. The well 52 of FIG. 3 uses a gas lift system, which comprises a source of lift gas 56 and a down hole mandrel 58. Oil flows into casing through perforations in the casing below the packer 60. The mandrel 58 and tubing that leads to the surface are located within the casing, but are fluidly isolated from the annulus 62 above the packer 60. Lift gas 56 is pumped into the annulus 62 at the surface, and flows toward the mandrel 58. The lift gas enters the mandrel 58 through a gas lift valve (not specifically shown), as illustrated by arrow 61. The lift gas and the oil mix, thereby “aerating” the oil and making it less dense, which then allows the formation pressure to push the oil column to the surface to the production piping 64.

Similar to the system of FIG. 1, the system of FIG. 3 comprises a processor 51 proximate to the wellhead 54, and the processor is coupled to monitoring devices such as pressure transmitters 66 and 68 and a temperature transmitter 70. In accordance with at least some embodiments, the pressure transmitter 66 detects pressure of the hydrocarbons at the surface, such as in production piping 64. Likewise, in some embodiments the temperature transmitter 70 detects temperature of the hydrocarbons in the production piping 64. In alternative embodiments, the pressure transmitter 66 and temperature transmitter 70 sense pressure and temperature respectively at a down hole location, such as within the area below the packing 60 and/or in the mandrel 58. The alternative embodiments where down hole pressure and temperature are sensed are illustrated by dashed lines 72 and 74. In yet still further embodiments, both surface and down hole pressures and temperatures are sensed. FIG. 3 also illustrates a pressure transmitter 68 senses the pressure of the lift gas, such as by being fluidly coupled to the annulus 62. FIG. 3 illustrates the pressure transmitters 66, 68 and temperature transmitter 70 at the surface, but in alternative embodiments these devices may be physically located down hole, with their measurement parameters sent up hole by way of electrical conductors.

In accordance with some embodiments, the processor 51 monitors pressure and temperature, and periodically reports the pressure and temperature to a remotely located asset management system. Further, the processor 51 may, acting on its own or based on commands from remote locations, control production of the well 52. In the case of the illustrative well 52 using a gas lift system, the processor 51 may control production by selectively supplying the lift gas. In addition, and in accordance with some embodiments, the processor 51 is configured to diagnose the causes of changes in production parameters for which direct measurement is not performed (e.g., flow measurement at the wellhead), or for which physical inspection of the site has heretofore been required. Much like the system of FIG. 1 utilizing a pump jack 14, normally occurring fluctuations in monitored parameters make it difficult to diagnose the causes of changes in production parameters.

As an example of the potential shortcomings in trying to diagnose causes of changes consider the system 50 of FIG. 3 attempting to determine whether there has been a reduction in the flow rate of produced hydrocarbons caused by mechanical problems associated with the gas lift system or the well completion. A reduction in surface measured pressure may be indicative of a flow reduction; however, a change of pressure down hole (formation pressure) affects flow rate (higher down hole pressure, more surface flow), and thus a reduction surface pressure alone may not indicate a mechanical problem if accompanied by a proportional formation pressure drop. Similarly, a reduction in surface measured pressure may not be indicative of mechanical problems if accompanied by a change in gas lift pressure. Compounding the difficulty in making determinations with respect to gas lift systems is that both gas lift pressure being too high and too low may cause flow reductions in gas lift systems. Thus, in determining the existence of changes in production parameters the magnitude of a surface measured pressure change needs to be considered with the magnitude of surface temperature change (if any) along with the magnitude of formation pressure change (if any) and the gas lift pressure.

The various embodiments address these difficulties by having processor 51 implement an artificial intelligence classifier. Viewing and analyzing various pressures, temperatures and possibly other parameters, the artificial intelligence implemented in the processor 51 makes determinations as to the causes of changes in production parameters, and reports causes to the asset management system. Based on the reporting, crews may be sent to the particular wellhead to fix the underlying mechanical problem. A non-limiting list of causes of production parameter changes that the processor 51 may report for the system of FIG. 3 is: flow reductions indicative of mechanical problems; abnormally high sand production; high water production; high gas production; inappropriate gas lift pressure; completion changes; and packer seal leakage.

Many other types of hydrocarbon production systems may likewise utilize the processor and artificial intelligence systems discussed with respect to FIGS. 1 and 3. For example, in a well using an electric submersible pump as the lift mechanism, a processor implementing artificial intelligence classifier may make determinations as to the cause of production parameter changes by monitoring surface and down hole pressure, pump discharge pressure, pump electrical power consumption, pump electrical current draw, surface and down hole hydrocarbon temperatures, and pump outlet temperature. An illustrative list of the determinations that may be made is: flow reductions indicative of mechanical problems; abnormally high sand production; high water production; high gas production; completion changes; and high motor power consumption unrelated to hydrocarbon viscosity changes.

FIG. 4 illustrates a method in accordance with various embodiments. In particular, the method starts (block 400) and proceeds to measuring a plurality of parameters associated with a hydrocarbon producing well (block 404). The measuring may take many forms. In some embodiments, surface parameters may be measured (e.g., pressure, temperature, current draw, power consumption). In other embodiments, down hole parameters may be measured (e.g., formation pressure, down hole temperature). In other embodiments, both surface and down hole parameters may be measured. Regardless of the number and/or type of parameters measured, the illustrative method may proceed to determining by an artificial intelligence program executed in a processor proximate to the hydrocarbon producing well a cause of a change in at least one of the parameters (block 408), and the illustrative method ends (block 412). In some embodiments, the determining may take the form of an artificial intelligence classifier (e.g., a neural network, support vector machine, k-nearest neighbor algorithm, Gaussian mixture model, Bayes classifier, or decision tree). The causes likewise may take many forms. In the case of a hydrocarbon producing well utilizing a pump jack, the causes of the changes in production parameters may be flow reductions indicative of mechanical problems, abnormally high sand production, sucker rod stretch, pump jack arm stretch, sucker rod assembly breakage, down hole pump seal leakage or completion changes. In the case of a hydrocarbon producing well being a gas lift system, the causes of the changes in production parameters may be formation pressure change, high gas lift pressure, low gas lift pressure, or completion changes. In the case of a hydrocarbon producing oil well using a submersible pump, the causes of the changes in production parameters may be flow reductions indicative of mechanical problems, abnormally high sand production, high water production, high gas production, high motor power consumption unrelated to hydrocarbon viscosity changes, or completion changes.

From the description provided herein, those skilled in the art are readily able to combine software created as described with appropriate general purpose or special purpose computer software to create a computer system and/or computer subcomponents in accordance with the various embodiments, to create a computer system and/or computer subcomponents for carrying out the methods of the various embodiments and/or to create a computer-readable media for storing a software program (e.g., an operating system) to implement the method aspects of the various embodiments.

The above discussion is meant to be illustrative of the principles and various embodiments of the present invention. Numerous variations and modifications will become apparent to those skilled in the art once the above disclosure is fully appreciated. For example, the various embodiments have been discussed in relation to wells producing (at least in part) oil, but the technology likewise applies to natural gas wells and may be used to diagnose changes such as changes in liquid entrainment. Further still, the various embodiments also find use in free flowing hydrocarbon wells, such as to make determinations as to whether flow reductions are formation or mechanically based. In embodiments that use a down hole pressure as part of the analysis, that down hole pressure may be directly measured, modeled within the processor proximate to the well based on existing conditions, or modeled from within processor doing field-wide down hole pressure modeling and being supplied to the local processor. From a system standpoint, the various embodiments are discussed in terms of devices that measure relevant parameters and communicate by way of electrical conductors; however, any communication system may be used, such as wireless and/or optical coupling. It is intended that the following claims be interpreted to embrace all such variations and modifications.

What is claimed is:

1. A system comprising:
a plurality of devices configured to measure production parameters associated with a hydrocarbon producing well; and
a processor proximate to a wellhead of the hydrocarbon producing well and electrically coupled to the plurality of devices;
wherein the processor is configured to diagnose a cause of a change of a production parameter.

2. The system according to claim 1 wherein the processor is configured to diagnose the cause of the change of the production parameter by implementing an artificial intelligence classifier.

3. The system according to claim 1 wherein the processor is configured to diagnose the cause of the change of the production parameter by implementing an artificial intelligence classifier being at least one selected from the group consisting of: a neural network; support vector machine; k-nearest neighbor algorithm; Gaussian mixture model; Bayes classifier; and decision tree.

4. The system according to claim 1 wherein the hydrocarbon producing well does not utilize a hydrocarbon flow measurement device, and wherein the processor is configured to diagnose the cause as a reduction in hydrocarbon flow.

5. The system according to claim 1 wherein the processor is configured to diagnose the cause as a change in completion status of the hydrocarbon producing well.

6. The system according to claim 1 wherein the processor is configured to diagnose the cause as an increase in sand production from the hydrocarbon producing well.

7. The system according to claim 1 wherein the processor is configured to diagnose the cause as a change in liquid entrainment in the hydrocarbon producing well being a natural gas well.

8. The system according to claim 1 further comprising:
wherein the hydrocarbon producing well utilizes a pump jack and sucker rod assembly to move the hydrocarbons to the surface; and
wherein the processor is configured to diagnose the cause as a change as at least one selected from the group consisting of: sucker rod assembly breakage; sucker rod stretch; pump jack arm stretch; and downhole pump seal leakage.

9. The system according to claim 1 further comprising:
wherein the hydrocarbon producing well utilizes a gas lift system; and
wherein the processor is configured to diagnose the cause as at least one selected from the group consisting of: high gas lift pressure; and low gas lift pressure.

10. The system according to claim 1 wherein the processor is further configured to send an indication of the cause of the change in production parameters to a remote management device.

11. The system according to claim 1 wherein the processor is further configured to send an indication of the cause of the change in production parameter being at least one selected from the group: change in production flow; abnormally high sand production; abnormally high liquid production; abnormally higher water production; sucker rod assembly breakage; sucker rod assembly stretch; pump jack arm stretch; down hole pump seal leak; and gas lift pressure low.

12. The system according to claim 1 wherein the plurality of devices further comprises devices selected from the group consisting of: a pressure transmitter configured to measure pressure in a production tubing; a pressure transmitter configured to measure pressure proximate to perforations in a casing; a temperature transmitter configured to measure temperature in a production tubing; a pressure transmitter configured to measure temperature proximate to perforations in the casing; and a current transformer configured to measure electrical current to a motor of a pump jack.

13. A method comprising:
measuring a plurality of parameters associated with a hydrocarbon producing well; and
determining by an artificial intelligence program executed in a processor proximate to the hydrocarbon producing well a cause of a change in at least one of the parameters.

14. The method according to claim 13 wherein determining further comprises determining by way of an artificial intelligence classifier.

15. The method according to claim 13 wherein determining further comprises determining by way of an artificial intelligence classifier being at least one selected from the group consisting of: a neural network; support vector machine; k-nearest neighbor algorithm; Gaussian mixture model; Bayes classifier; and decision tree.

16. The method according to claim 13 further comprising:
wherein measuring further comprises measuring the plurality of parameters without directly measuring hydrocarbon flow; and
wherein determining further comprises determining the cause as a change in hydrocarbon flow

17. The method according to claim 13 wherein determining further comprises determining the cause as at least one selected from the group consisting of: a change in completion status of the hydrocarbon producing well; an increase in sand production from the hydrocarbon producing well; sucker rod assembly breakage; sucker rod stretch; pump jack arm stretch; downhole pump seal leakage; high gas lift pressure; and low gas lift pressure.

18. The method according to claim 13 wherein determining further comprises determining the cause as a change in liquid entrainment in the hydrocarbon producing well being a natural gas well.

19. The method according to claim 13 wherein measuring further comprises measuring pressure and temperature associated with a hydrocarbon producing well.

20. The method according to claim 19 wherein measuring pressure further comprises measuring the pressure at a location being at least one selected from the group consisting of: at the surface proximate to the hydrocarbon producing well; and downhole.

21. The method according to claim 19 wherein measuring temperature further comprises measuring the temperature at a location being at least one selected from the group consisting of: at the surface proximate to the hydrocarbon producing well; and downhole.

22. A computer-readable medium storing a program that, when executed by a processor, causes the processor to:
read a plurality of production parameters directly from transmitters associated with a hydrocarbon producing well; and
classify at least some of the parameters to determine a cause of a change in at least one of the parameters.

23. The computer-readable medium according to claim 22 wherein when the processor classifies the program causes the processor to classify using at least one selected from the group consisting of: a neural network; support vector machine; k-nearest neighbor algorithm; Gaussian mixture model; Bayes classifier; and decision tree.

24. The computer-readable medium according to claim 22 wherein when the processor classifies the program causes the processor to determine the cause as at least one selected from the group consisting of: a change in completion status of the hydrocarbon producing well; an increase in sand production from the hydrocarbon producing well; sucker rod assembly breakage; sucker rod stretch; pump jack arm stretch; downhole pump seal leakage; high gas lift pressure; and low gas lift pressure.

25. The computer-readable medium according to claim 22 wherein when the processor classifies the program causes the processor to determine the cause as a change in liquid entrainment in the hydrocarbon producing well being a natural gas well.

26. The computer-readable medium according to claim 22 wherein when the processor reads the program causes the processor to read the plurality of production parameters by way of at least one selected from the group consisting of: an analog to digital converter coupled to the processor; and a digital communication port coupled to the processor.
